(19) United States
(12) Patent Application Publication
(10) Pub. No.: US 2013/0129604 A1
(43) Pub. Date: May 23, 2013

(54) METHOD FOR PRODUCING AMMONIUM DICHROMATE

(71) Applicants: Holger Friedrich, Newcastle (ZA); Rainer Ortmann, Koln (DE); Matthias Stenger, Monheim (DE); Matthias Boll, Koln (DE); Daniel Van Rooyen, Newcastle (ZA); Naveen Kalideen, Newcastle (ZA)

(72) Inventors: Holger Friedrich, Newcastle (ZA); Rainer Ortmann, Koln (DE); Matthias Stenger, Monheim (DE); Matthias Boll, Koln (DE); Daniel Van Rooyen, Newcastle (ZA); Naveen Kalideen, Newcastle (ZA)

(73) Assignee: LANXESS DEUTSCHLAND GMBH, Leverkusen (DE)

(21) Appl. No.: 13/518,107

(22) PCT Filed: Dec. 8, 2010
(86) PCT No.: PCT/EP10/69219

§ 371 Date: Feb. 7, 2013

(30) Foreign Application Priority Data
Dec. 22, 2009 (EP) 09180375.9

(51) Int. Cl. C01G 37/14

(52) U.S. Cl. CPC C01G 37/14
USPC 423/597

(57) ABSTRACT

Process for preparing ammonium dichromate, comprising the steps of
c) thermally decomposing an alkali metal ammonium chromate double salt, especially a sodium ammonium chromate double salt or hydrates thereof, at a temperature up to 200° C., especially of 75 to 190° C., to form ammonium dichromate and
d) removing the ammonium dichromate from the decomposition product obtained after step c), by crystallization,
   characterized in that the alkali metal ammonium chromate double salt corresponds to the formula

Mₓ(NH₄)_{y}CrO₄

or hydrates thereof,
in which
M is Na or K, particular preference being given to Na,
x is from 0.1 to 0.9, preferably from 0.4 to 0.7,
y is from 1.1 to 1.9, preferably from 1.3 to 1.6, and
   the sum of x and y is 2.

The invention relates to a process for preparing ammonium dichromate proceeding from alkali metal ammonium chromate double salts.

Chromium(III) oxide is a versatile product with a wide range of applications. For instance, it can be used as a pigment for colouring different application media, for example building materials, plastics, paints and coatings, glasses or ceramics. For this field of use, a minimum content of water-soluble impurities is required.

In addition, chromium (III) oxide is also used in abrasives and high-temperature-resistant materials. For the use of chromium(III) oxide in high-temperature-resistant materials, a minimum alkali metal content is desired in order to as far as possible suppress the oxidation of Cr(III) to alkali metal chromate, which is favoured at high temperatures in the presence of alkali metal ions.

A further important field of industrial use for chromium(III) oxide is use as a starting material for the production of chromium metal and/or chromium-containing high-performance alloys. It is generally possible here to use only chromium(III) oxides which feature a low sulphur content and a low carbon content. The term “low-sulphur chromium(III) oxide” is therefore frequently used as a synonym for “chromium(III) oxide for metallurgical purposes”.

According to the prior art, chromium(III) oxide can be prepared by various processes. It is usually prepared from hexavalent chromium compounds at elevated temperatures, and different degrees of purity can be achieved. The starting compounds of hexavalent chromium used are chromic acid, ammonium chromates or alkali metal chromates. The reaction can be carried out with or without addition of a reducing agent. The reducing agents used are organic or inorganic reducing agents, such as sawdust, molasses, cellulose waste liquors, acetylene, methane, sulphur and compounds thereof, phosphorus, carbon, hydrogen and the like. Such processes are described in numerous property rights. By way of example, mention shall be made merely of U.S. Pat. No. 1,893,761 and DE-A-20 30 510. U.S. Pat. No. 1,893,761 discloses the preparation of chromium(III) oxide by the reduction of alkali metal chromates with organic substances. In the case of use of carbon or organic compounds as the reducing agent, the process can be conducted such that sodium carbonate is ultimately obtained as a by-product, as already mentioned in U.S. Pat. No. 1,893,761. This can optionally be recycled into the process for producing sodium dichromate when the sodium dichromate is prepared via an oxidative alkaline digestion proceeding from chromium ore. However, the chromium(III) oxide obtained in this way contains a high carbon content which makes it unsuitable for metallurgical use. DE-A-20 30 510 describes a process for continuously preparing very pure, low-sulphur chromium(III) oxide by reducing alkali metal chromates with hydrogen at relatively high temperatures, and an apparatus suitable therefor. The reaction temperature is between 1000-1800° C., advantageously between 1100-1400° C., and the product obtained is separated from the offgas with the aid of an alkalized dispersion. A disadvantage of all these processes which work with a reducing agent is, however, that the use of the reducing agent inevitably results in a by-product which has to be worked up.

The thermal decomposition of pure ammonium dichromate, in contrast, does not itself lead to any significant inevitable occurrence of a by-product, since it ideally proceeds according to the reaction equation (1):

(NH₄)₂Cr₂O₇→Cr₂O₃+N₂+4H₂O (1)

from a temperature of approx. 200° C. However, the industrial processes nowadays being practised for preparation of ammonium dichromate proceed from alkali metal dichromates—usually sodium dichromate. In this case, the sodium dichromate is reacted with ammonium chloride or ammonium sulphate to give ammonium dichromate and sodium chloride, or to give ammonium dichromate and sodium sulphate. Chromium(III) oxide for metallurgical purposes used to be produced industrially by calcining, in a furnace, a mixture of ammonium dichromate and sodium chloride, which was obtained by in situ reaction of sodium dichromate and ammonium chloride in virtually stoichiometrically equivalent amounts. The calcination temperature should be above 700° C. in order to ensure that the reaction mixture has a high chromium(III) oxide content; at too high a temperature, however, there is an increasing risk of slag formation in the furnace, and the temperature is therefore generally kept below 850′C.

The use of ammonium sulphate instead of ammonium chloride is frequently preferred since ammonium chloride, owing to its low sublimation temperature, sublimes off in the form of NH₃ and HCl in the course of calcination, and can thus get into the waste air. For this reason, the use of ammonium chloride is no longer of any economic significance. However, the disadvantage of use of ammonium sulphate is that sulphur is entrained into the production process in this way, even though a chromium(III) oxide with a minimum sulphur content is desired.

DE-A-26 35 086 (U.S. Pat. No. 4,235,862) discloses a process for preparing a low-sulphur chromium(III) oxide, which is characterized by calcination of a mixture of alkali metal dichromate and ammonium sulphate at a calcination temperature of 800 to 1100° C. and removal of the chromium(III)oxide formed from alkali metal salt formed, using 0.7 to 0.89 and preferably 0.7 to 0.84 mol of ammonium sulphate per mole of alkali metal chromate. After the calcination, the chromium(III) oxide is worked up in a conventional manner by washing out water-soluble salts and drying. After this process, sulphur contents in the chromium(III) oxide of 50 to 100 ppm can be achieved. A disadvantage of this process is that, to achieve low sulphur contents, the starting substances must not be mixed in a stoichiometric ratio, and ammonium sulphate is used in a distinct deficiency. This results in low conversions in the region of approx. 90%, and maintenance of a high calcination temperature is required. The alkali metal dichromate present owing to the excess decomposes thermally to alkali metal chromate, chromium(III) oxide and oxygen. Thus, the reaction gives rise not only to a large amount of alkali metal sulphate (for example sodium sulphate) but also always alkali metal chromate (for example sodium chromate), which gets into the mother liquor or washing liquid in the course of later washing, and then has to be removed in order to recycle it into the process if appropriate. The mother liquor, however, then also contains the alkali metal sulphate which is inevitably obtained and has to be purified in a complex manner since it is always contaminated with alkali metal chromate. Moreover, the conditions proposed for preparation of low-sulphur chromium(III) oxide have been found to be difficult to implement in practice, since the sodium sulphate content of the reaction mixture leads to caking at the high temperatures required (melting temperature of sodium sulphate approx. 885° C.) and hence to disruptions in the production cycle.

For preparation of chromium(III) oxide with relatively low sulphur contents, U.S. Pat. No. 4,296,076 discloses a process in which, inter alia, sodium dichromate and ammonium chloride or sodium dichromate and ammonium sulphate are used. In contrast to DE-A-26 35 086, in this case, essentially a stoichiometric ratio is selected or, preferably, an excess of the ammonium compound is used. In a first reaction step, the starting compounds are converted to ammonium dichromate and sodium chloride or ammonium dichromate and sodium sulphate. In the examples disclosed, this reaction step takes place at 400 to 800° C., followed by the aqueous workup and then by a second calcination process at a temperature above 1100° C. According to this process, sulphur contents in the chromium(III) oxide of below 40 ppm are achieved. In this process, however, large amounts of sodium chloride or sodium sulphate are obtained, which have to be purified in a complex manner. Moreover, the use of the ammonium compounds mentioned, especially of ammonium chloride, is not unproblematic because they sublime very readily and can thus get into the offgas air.

Another process described in the prior art for preparing high-quality chromium(III) oxide is disclosed in RU 2 258 039. Although ammonium dichromate—obtained by reaction of sodium dichromate with ammonium sulphate in the aqueous phase—is used here too for the preparation of chromium(III) oxide, the sodium sulphate inevitably obtained in the reaction is removed from the reaction mixture, such that a relatively pure, i.e. low-sulphur, ammonium dichromate is decomposed thermally to chromium(III) oxide. Sodium sulphate is therefore always obtained as a by-product, which has to be purified in a complex manner since it is contaminated with Cr(VI). The calcination proceeding from the ammonium dichromate is effected in one stage at a temperature of 440-1400° C. in a drum furnace. This procedure, however, has been found to be disadvantageous since it leads to a high Cr(VI)-containing fines content, some of which is incompletely decomposed and has to be separated out and sent back to the calcination, such that a lot of material is within the recycling operation.

A preferred process for preparing chromium(III) oxide, especially for metallurgical purposes, which does not have the disadvantages mentioned

comprises the steps of
a) thermally decomposing ammonium dichromate at a temperature of 200 to 650° C., especially of 210 to 550° C., preferably of 210 to 430° C., and
b) subsequently calcining the decomposition product obtained from step a) at a temperature of 700 to 1400° C., especially of 800 to 1300° C.,
   characterized in that step a) is effected in an indirectly heated reactor and step b) in a directly heated reactor.

### Step a)

The thermal decomposition of the ammonium dichromate in step a) is effected in the process preferably at a temperature of 200 to 650° C., more preferably of 210 to 550° C., most preferably at 210 to 430° C., especially over a period of 5 to 300 minutes, more preferably of 30 to 240 minutes. The thermal decomposition can be effected, for example, in an indirectly heated rotary tube furnace, chamber furnace, or in a fluidized bed. Particular preference is given to using an indirectly heated rotary tube furnace for the thermal decomposition of the ammonium dichromate.

The ammonium dichromate used with preference has a sodium content of less than 2% by weight, especially less than 1% by weight, more preferably less than 0.5% by weight, most preferably less than 0.2% by weight, calculated as sodium metal.

The thermal decomposition in step a) is preferably effected under standard pressure or under reduced pressure.

The decomposition product obtained after step a) can be washed before it is supplied to step b). In general, such a wash, however, is unnecessary. Advantageously, it is only the chromium(III) oxide obtained after step b) that is washed.

### Step b)

The thermal treatment at elevated temperature, i.e. the calcination, of the decomposition product obtained from step a), in step b), is effected at a temperature of 700 to 1400° C., more preferably of 800 to 1300° C. This is preferably effected over a period of more than 20 minutes, more preferably of more than 30 minutes. For calcination at such high temperatures, the person skilled in the art is aware of a multitude of directly heatable reactors. Mention as preferable shall be made at this point merely of circular hearth furnaces, but especially of rotary tube furnaces.

The residence time of the material to be calcined is, according to the configuration and length of the furnace, preferably 30 minutes to 4 hours. The calcination is effected preferably under air or in an atmosphere composed of pure oxygen, or in an atmosphere composed of air optionally enriched with oxygen.

In a particularly preferred variant of the process, the thermal decomposition of the ammonium dichromate in step a) and/or the calcination in step b) is preceded by addition of one or more alkali metal halides or ammonium halides or alkaline earth metal halides, especially the fluorides, chlorides, bromides or iodides of sodium or potassium or ammonium, or alkali metal hydroxides, especially sodium hydroxide, or potassium hydroxide, or chromic acid, in an amount of 0.01% by weight to 3.0% by weight, more preferably of 0.02% by weight to 1.0% by weight, based on the ammonium dichromate used or the decomposition product obtained. Such additions allow the performance properties to be influenced, especially the increase in the bulk density of the resulting chromium(III) oxide.

The chromium(III) oxide obtained after the calcination in step b) is preferably cooled and optionally ground. In a particularly preferred variant of the process, the calcined product is leached with water after step b), which gives rise to a mother liquor, and washed, which gives rise to washing water, and then dried again. The wash can be effected analogously to the procedure described in step d) below. The leaching and washing allow water-soluble impurities (water-soluble salts) still present in the chromium(III) oxide—essentially sodium chromate, which has formed as a result of oxidation of chromium(III) oxide at high temperatures—to be washed out by known processes in one or more stages with water or aqueous media, and the solids to be removed from the liquid. The preferred embodiments for the solid/liquid separation and the washing are as specified below in step d).

The chromium(III) oxide obtained after step b) generally has good filtration and washing properties. The moist chromium(III) oxide obtained after the solid/liquid separation is then preferably dried. The optionally dried chromium(III) oxide is preferably subjected to grinding.

For the optional drying step, the person skilled in the art is aware of a multitude of suitable units. Mention shall be made at this point merely of channel dryers, belt dryers, stage dryers, roll dryers, drum dryers, tubular dryers, paddle dryers, spray dryers (atomization dryers with plates or nozzles), fluidized bed dryers or batchwise staged chamber dryers.

According to the drying unit selected, it may be necessary for another grinding step to follow. However, even when the calcined product is not washed and dried, grinding may be advantageous. The calcined and optionally washed and optionally dried product is preferably subjected to grinding. Suitable for this purpose are grinding units of different design, for example roll mills, pan mills, pendulum mills, hammer mills, pin mills, turbo mills, ball mills or jet mills. When the calcined product has been washed, it is particularly advantageous to use a grinding dryer, in which drying and grinding are effected in only one operation. The selection of the suitable grinding assembly is guided by factors including the particular field of use for the chromium(III) oxide prepared.

When the calcined chromium(III) oxide from step b) is leached or washed with water, the mother liquors and the particular washing waters in both cases comprise essentially alkali metal chromate, especially sodium chromate, and/or alkali metal dichromate, especially sodium dichromate. The mother liquors and the particular washing waters from the inventive preparation of ammonium dichromate, comprising steps c) and d), may additionally also comprise ammonium dichromate. These substances of value can be recycled back into the production process, by using them, for example, for the preparation of sodium dichromate or—most preferably—for the preparation of a sodium ammonium chromate double salt, especially as described below. More preferably, mother liquors and washing waters which are obtained in the solid/liquid separation and washing of the ammonium dichromate and/or calcined product are used again for the preparation of sodium dichromate or of an alkali metal ammonium chromate double salt, especially sodium ammonium chromate double salt. They are most preferably used for the preparation of an alkali metal ammonium chromate double salt.

The chromium(III) oxide prepared by the process is highly pure. It is consequently outstandingly suitable for metallurgical purposes, such as the production of chromium metal or chromium-containing high-performance alloys, especially by reduction in the presence of aluminium metal via the aluminothermic process, and for the production of high-temperature-resistant materials, but it can also be used as a colour pigment for pigment applications, since it also has a very low content of water-soluble salts.

The chromium(III) oxide obtained by the process is highly pure and especially very low in sulphur. Chromium(III) oxides “low in sulphur” in the context of this invention are considered to be those which have a sulphur content of less than 200 ppm, preferably less than 50 ppm, most preferably less than 40 ppm. Chromium(III) oxides “low in sodium” in the context of this invention are considered to be those which have a sodium metal content—calculated as sodium metal—of less than 1500 ppm, preferably less than 500 ppm.

The advantage of the process over that from RU 2 258 039 C1 is especially that the amount of dust is reduced and does not have to be circulated as such.

The chromium(III) oxide prepared by the process can be used as a colour pigment, abrasive, and as a starting material for the production of high-temperature-resistant materials, chromium metal or chromium-containing high-performance alloys, especially by reduction in the presence of aluminium metal via the aluminothermic process.

The invention therefore relates to a process for preparing ammonium dichromate, comprising the steps of
c) thermally decomposing an alkali metal ammonium chromate double salt, especially a sodium ammonium chromate double salt or hydrates thereof, at a temperature up to 200° C., especially of 75 to 190° C., to form ammonium dichromate and
d) removing the ammonium dichromate from the decomposition product obtained after step c), by crystallization, characterized in that the alkali metal ammonium chromate double salt corresponds to the formula

Mₓ(NH₄)_{y}CrO₄

or hydrates thereof,
in which
M is Na or K, particular preference being given to Na,
x is from 0.1 to 0.9, preferably from 0.4 to 0.7,
y is from 1.1 to 1.9, preferably from 1.3 to 1.6, and
the sum of x and y is 2.

### Step c)

Sodium ammonium chromate double salts are known, for example, in CN1418821 for preparation of sulphur-free chromium oxide by calcination at 650-1200° C. proceeding from a 1:1 alkali metal ammonium chromate double salt.

Also known from Acta Phys.-Chim. Sin, 21 (2) 2005, p. 218-220 is the double salt NaNH₄Cra₄*2H₂O, which crystallizes in the P2₁2₁2₁ space group with the lattice parameters a=841.3(5) pm, b=1303.9(8) pm and c=621.9(4) pm, and Z=4, and is isostructural to NaNH₄SO₄.2H₂O (see Acta Cryst., B28 1972, p. 683-93). However, only the thermolysis of the 1:1 sodium ammonium chromate double salt is studied analytically therein.

It is preferred that the alkali metal ammonium chromate double salt, especially the sodium ammonium chromate double salt, has a molar ammonium:alkali metal, especially ammonium:sodium, ratio of 2.

The optimal temperature range is guided by factors including whether the thermal decomposition is carried out, for example, in the solid state or in aqueous solution.

The thermal decomposition of the alkali metal ammonium chromate double salt, especially sodium ammonium chromate double salt, preferably takes place at a temperature of 75 to 190° C. The preferred reaction time is 15 to 240 minutes.

The thermal decomposition in step c) is preferably effected under standard pressure or under reduced pressure.

The thermal decomposition in step c), especially of the sodium ammonium chromate double salt, preferably takes place in the solid state, especially at a temperature of 120 to 190° C., more preferably of 120 to 170° C. The thermal decomposition of the sodium ammonium chromate double salt to ammonium dichromate and sodium dichromate or ammonium dichromate and sodium chromate in the solid state need not necessarily proceed to completion. Preference is given to effecting the thermal decomposition until less than 98%, but more than 50%, especially more than 75%, of the monochromate originally present from the alkali metal ammonium chromate double salt has been converted to dichromate. In this context, it is possible to determine what is called the “degree of deacidification”, which is at 0% when 100% of monochromate is still present, and is 100% when 100% has been converted to dichromate. The degree of deacidification is preferably determined via titration.

In the case of an incomplete thermal decomposition, the decomposition product obtained from step c) generally comprises, as well as sodium, ammonium and dichromate ions, also monochromate ions. When the thermal decomposition of the alkali metal ammonium chromate double salt is effected at excessively high temperatures and/or for excessively long reaction times, a portion of the ammonium dichromate formed may react further. In this case, the ammonium dichromate may decompose to an X-ray-amorphous product which no longer dissolves on dissolution in water. It remains as a brown, flaky, undissolved residue. However, this does not fundamentally disrupt the preparation process, as will be explained below.

The thermal decomposition in step c), especially of the alkali metal ammonium chromate double salt, preferably takes place in aqueous solution at a temperature of 75 to 110° C. This method of decomposition has the significant advantage over the already described thermal decomposition of the alkali metal ammonium chromate double salt in the solid state that the thermal decomposition in aqueous solution proceeds at lower temperatures and, secondly, further thermal decomposition to undesired by-products is inhibited. The thermal decomposition is preferably conducted until less than 98%, but more than 50%, especially more than 75%, of the monochromate originally present has been converted to dichromate.

In the case of an incomplete thermal decomposition, the decomposition product obtained from step c) may, as well as sodium, ammonium and dichromate ions, generally also contain monochromate ions. In the aqueous thermal decomposition, it is additionally also possible to add chromic anhydride CrO₃ to the aqueous solution, which can influence the conversion of monochromate to dichromate.

When the thermal decomposition of the sodium ammonium chromate double salts takes place in the solid state, it is preferred when the solid decomposition product obtained is dissolved in water before it can be supplied to step d). For this purpose, preference is given to using warm water, especially with a temperature of 30 to 100° C. When the thermal decomposition of the sodium ammonium chromate double salt takes place in an aqueous solution, a warm aqueous solution is usually already present in any case, which can be supplied to step d).

More preferably, however, the aqueous solution of the decomposition product as per step c) is concentrated before it is supplied to step d). This is more preferably effected by evaporative concentration. The evaporative concentration can be effected under standard pressure, but it is generally undertaken under reduced pressure. For this purpose, the person skilled in the art is aware of a multitude of technical apparatuses in which, by supply of heat, water is evaporated out of a solution and can be withdrawn, such that the remaining solution has a higher concentration of dissolved ions. Mention shall be made at this point merely of still evaporators, tubular evaporators or thin-film evaporators. Preference is given to using evaporator systems with mixture preheating, with vapour compression or multitube evaporation systems.

The thermal decomposition of the sodium ammonium chromate double salt in step c) is associated with the release of ammonia, as illustrated by reaction equation (7) using the example of the 1:1 double salt.

4NaNH₄CrO₄→2Na₂CrO₄+(NH₄)₂Cr₂O₇+H₂O+2NH₃ (7)

More preferably, the process according to the invention is conducted in such a way that the ammonia released in the thermal decomposition of the alkali metal ammonium chromate double salt, especially of the sodium ammonium chromate double salt, is recovered as a gas or aqueous solution and used again for the preparation of the sodium ammonium chromate double salt. The ammonia gas released is preferably condensed in the form of an aqueous ammonia solution and then either used directly in the form of ammonia solution or optionally, after being split again into gaseous ammonia and water, used again for the preparation of the alkali metal ammonium chromate double salt, especially sodium ammonium chromate double salt.

### Step d)

Ammonium dichromate is then crystallized out of the decomposition product obtained from step c), preferably obtained in the form of an aqueous solution of the decomposition product which has optionally been concentrated, and the solids obtained are preferably removed from the mother liquor. Crystallization in the context of this invention is understood to mean the separation of a crystalline solid out of a solution.

The ammonium dichromate can be crystallized by means of evaporative crystallization, cooling crystallization or vacuum crystallization. The person skilled in the art is aware of a multitude of crystallization apparatuses which work by these principles. Preferably, ammonium dichromate is separated out of an aqueous solution of the decomposition product as per step c) by cooling crystallization, and is removed from the mother liquor, preferably by solid-liquid separation, and optionally washed. In the cooling crystallization, the hot aqueous solution of the decomposition product as per step c) is preferably cooled to a temperature of 50 to −10° C., especially 40 to −5° C.

In some cases, it may be advantageous to trigger and to accelerate the crystallization of the ammonium dichromate by seeding, i.e. by adding crystal fragments or crystal powder which act(s) as crystallization nuclei.

The solid ammonium dichromate is preferably removed from the mother liquor in the solid/liquid mixture obtained after the crystallization of the ammonium dichromate. For the solid/liquid separation, the person skilled in the art is aware of a multitude of suitable units and processes. It is unimportant whether the solid/liquid separation is continuous or batchwise. It is likewise unimportant whether it is performed with pressure or under reduced pressure.

Among the continuous filtration units, for example, vacuum drum filters or vacuum belt filters are particularly preferred. Of the batchwise filtration units, filter presses are particularly preferred.

The preferred further use of the mother liquor and washing waters obtained from the solid/liquid separation has already been described above.

When the thermal decomposition of the sodium ammonium chromate double salt in step c) leads to X-ray-amorphous product which remains as an undissolved residue on dissolution of the decomposition product in water, this can be filtered out of the solution before the crystallization of the ammonium dichromate or the evaporative concentration of the aqueous solution of the decomposition product. In practice, this separate separation step, however, is completely unnecessary since this undissolved residue can also be removed together with the ammonium dichromate after the crystallization of the ammonium dichromate in the course of the preferred solid/liquid separation already described above.

The insoluble residue removed can preferably also be fed to step a) or separately to step b) together with the ammonium dichromate. It is ultimately also converted to chromium(III) oxide. In this context, it is advantageous that the moist ammonium dichromate obtained after the solid/liquid separation is either supplied directly to the thermal decomposition in step a) or washed and/or dried beforehand. The moist ammonium dichromate obtained after the solid/liquid separation is preferably washed before it is optionally dried and then supplied to the thermal decomposition in step a). The washing can substantially displace the mother liquor still adhering, thus significantly lowering the alkali metal content of the ammonium dichromate obtained, as a result of which the purity rises significantly. The washing is preferably carried out in the same assembly which has also been used for the solid/liquid separation.

The preferred further use of the washing waters obtained from the washing of the ammonium dichromate has already been described above.

The moist filtercake is preferably supplied directly to the calcination, its handling in the dry state being significantly more difficult and demanding than in the moist state. It is therefore advantageous in an industrial process to dispense with the drying of the moist ammonium dichromate and to supply the moist filtercake directly to the thermal decomposition in step a).

For the optional drying step, the person skilled in the art is aware of a multitude of suitable units. Mention shall be made at this point merely of channel driers, belt driers, stage driers, roll dryers, drum dryers, tubular dryers, paddle dryers, spray dryers (atomization dryers with plates or nozzles), fluidized bed dryers or batchwise staged chamber dryers.

The process according to the invention for preparing ammonium dichromate is preferably characterized in that the alkali metal ammonium chromate double salt used is prepared by adding NH₃, preferably in a 1.0- to 5.0-fold, more preferably in a 1.4- to 4.5-fold, molar excess, based on alkali metal dichromate, especially M₂Cr₂O₇ in which M is Na or K, especially Na, at a temperature of 55 to 95° C. to an aqueous solution of alkali metal dichromate, especially M₂Cr₂O₇ or hydrates thereof, especially of Na₂Cr₂O₇ or Na₂Cr₂O₇^{*}2H₂O.

In S. W. Johnson “Chemische Notizen” Journal fü\vec{r} praktische Chemie, 62 (1) 1854, p. 261-264, a compound of the formula K(NH₄)Cr₂O₇ is prepared by reaction of NH₃ and K₂Cr₂O₇ under cold conditions.

Preference is given to the process for preparing the alkali metal ammonium chromate double salt used in step c), of the formula

Mₓ(NH₄)_{y}CrO₄

or hydrates thereof,
in which
M is Na of K, especially Na,
x is from 0.1 to 0.9, preferably from 0.4 to 0.7,
y is from 1.1 to 1.9, preferably from 1.3 to 1.6, and
the sum of x and y is 2, characterized in that NH₃ is added, preferably in a 1.0- to 5.0-fold, more preferably in a 1.4- to 4.5-fold, molar excess, based on alkali metal dichromate, especially on Na₂Cr₂O₇, preferably at a temperature of 55 to 95° C. to an aqueous solution of alkali metal dichromate, especially Na₂Cr₂O₇ or Na₂Cr₂O₇*2H₂O.

It is preferred that, for the process for preparing chromium(III) oxide, the ammonium dichromate used is prepared by the process according to the invention comprising at least steps c) and d) as described above in the general or preferred embodiment thereof. This combination of process steps for preparation of high-purity, low-sulphur chromium(III) oxide has numerous advantages over the processes described in the prior art. A significant advantage is that sodium chromate and/or sodium dichromate and ammonium dichromate form as by-products, which can be recycled back into the preparation process without any problem. Thus, there is no occurrence of a by-product which has to be discharged from the process and purified in a complex manner since it is contaminated with Cr(VI).

The invention is more particularly elucidated by the examples which follow, without any intention that this should cause a restriction of the invention.

### EXAMPLES

### Preparation of the Sodium Ammonium Chromate Double Salt

At 60° C., a 70% solution of sodium dichromate dihydrate (Na₂Cr₂O₇*2H₂O) was prepared by dissolution in water. Then 2.7 times the molar amount of ammonia in relation to sodium dichromate (Na₂Cr₂O₇) was added dropwise in the form of a 25% aqueous ammonia solution, in the course of which the temperature rose to 72° C. and the sodium ammonium chromate double salt precipitated out in the above-described crystal structure. Finally, the warm suspension was filtered, and the filtercake was washed with 99% ethanol and dried to constant weight at 100° C. Analysis of the resulting solids gave an ammonium:sodium ratio of 2.55 and, taking account of the conditions x+y=2, y=1.44 and x=0.56, and so the real composition of the sodium ammonium chromate double salt was Na_{0.56}(NH₄)_{1.44}CrO₄.

The sodium ammonium chromate double salt prepared in this way was used as the starting material for Examples 1 to 4 described below.

### Example 1

50 g of the above-described sodium ammonium chromate double salt were dissolved in 85 ml of hot water. The solution was then heated to boiling and concentration by evaporation until 76.7 g of solution remained. During the evaporative concentration, the steam always had an alkaline pH. The 76.7 g of solution had a pH of 6.5 at the boiling point and were cooled gradually to room temperature, in the course of which ammonium dichromate crystallized out. After approx. 16 hours, the ammonium dichromate crystals were filtered out of the mother liquor and washed with 15 ml of water. After drying, 12.75 g of ammonium dichromate were obtained, which had a sodium content of 0.093% by weight. The mother liquor obtained in the filtration had a sodium content of 100.4 g/l and an ammonium content of 42.7 g/l. It had a pH of 6.8.

### Example 2

50 g of the above-described sodium ammonium chromate double salt were dissolved in 100 ml of heated water. The solution was then heated to boiling and concentration by evaporation until 71.9 g of solution remained. During the evaporative concentration, the steam always had an alkaline pH. The 71.9 g of solution had a pH of 6.5 at the boiling point and were cooled gradually to room temperature, in the course of which ammonium dichromate crystallized out. After approx. 16 hours, the ammonium dichromate crystals were filtered out of the mother liquor and not washed. After drying, 20.31 g of ammonium dichromate were obtained, which had a sodium content of 1.94% by weight. The mother liquor obtained in the filtration had a sodium content of 115.9 g/l and an ammonium content of 30.0 g/l. It had a pH of 6.2.

### Example 3

The above-described sodium ammonium chromate double salt was decomposed in solid form at 130° C. over a period of 165 minutes. The decomposition product had a deacidification level of 88%. 50.1 g of this decomposition product were dissolved in 55 ml of hot water. The solution was then heated to boiling and concentration by evaporation until 81.1 g of solution remained. The 81.1 g of solution had a pH of 6.2 at the boiling point and were cooled gradually to room temperature, in the course of which ammonium dichromate crystallized out. After approx. 16 hours, the ammonium dichromate crystals were filtered out of the mother liquor and washed with 15 ml of water. After drying, 7.99 g of ammonium dichromate were obtained, which had a sodium content of 0.071% by weight. The mother liquor obtained in the filtration had a sodium content of 81.4 g/l and an ammonium content of 30.2 g/l. It had a pH of 6.1.

### Example 4

The above-described sodium ammonium chromate double salt was decomposed in solid form at 140° C. over a period of 95 minutes. The decomposition product had a deacidification level of 81%. 50.0 g of this decomposition product were dissolved in 40 ml of water at 75° C. Without further evaporative concentration, the solution was cooled gradually to +8° C., in the course of which ammonium dichromate crystallized out. After approx. 16 hours, the ammonium dichromate crystals were filtered out of the mother liquor and washed with 15 ml of water. After drying, 15.72 g of ammonium dichromate were obtained, which had a sodium content of 0.037% by weight. The mother liquor obtained in the filtration had a sodium content of 86.1 g/l and an ammonium content of 31.0 g/l. It had a pH of 6.6.

### Example 5

The ammonium dichromate obtained from the above examples was in each case decomposed gradually and gently under standard pressure in an indirectly heated furnace within the temperature range of 235-260° C. The decomposition product obtained still had a Cr(VI) content of 1.54%. This decomposition product was then calcined at a temperature of 820° C. in a directly heated furnace for 1 hour. The chromium(III) oxide obtained was leached with water, separated from the mother liquor, washed with water and separated from the washing water. Finally, it was dried and ground. A low-sulphur and low-sodium chromium(III) oxide was obtained, which is suitable for various fields of use.

### Example 6

The decomposition product described in Example 5 was calcined at a temperature of 1250° C. in a directly heated furnace for 1 hour. The chromium(III) oxide obtained was leached with water, separated from the mother liquor, washed with water and separated from the washing water. Finally, it was dried and ground. A low-sulphur and low-sodium chromium(III) oxide was obtained, which is suitable for various fields of use.

### Comparative Experiment

Analogously to Example 3 of the present invention, a 1:1 double salt of the formula Na(NH₄)CᵣO₄*2H₂O was decomposed at 130° C. over a period of 165 minutes. 50 g of the decomposition product obtained were dissolved in 55 ml of hot water. The solution was heated to boiling and concentrated by evaporation until 78.8 g of solution remained. The solution was cooled gradually to room temperature. After 16 hours, the crystals obtained were filtered off and washed with 15 ml of water. The crystals were analysed after drying. According to this procedure (C1) and a further procedure (C2), the following results, in particular sodium contents, were obtained:

| | Evaporative | | | |
|---|---|---|---|---|
| | concentration to | Cooled to | Washing | Na content |
| Example | x g of solution X | (T/° C.) | Yes/no | % by wt. |
| C1 | 78.8 | 20° C. (RT) | Yes | 15.51 |
| C2 | 86.3 | 8° C. | No | 13.80 |

What is claimed is:

1. Process for preparing ammonium dichromate, comprising the steps of
c) thermally decomposing an alkali metal ammonium chromate double salt, especially a sodium ammonium chromate double salt or hydrates thereof, at a temperature up to 200° C., especially of 75 to 190° C., to form ammonium dichromate and
d) removing the ammonium dichromate from the decomposition product obtained after step c), by crystallization,
characterized in that the alkali metal ammonium chromate double salt corresponds to the formula
Mₓ(NH₄)_{y}CrO₄
or hydrates thereof,
in which
M is Na or K, particular preference being given to Na,
x is from 0.1 to 0.9, preferably from 0.4 to 0.7,
y is from 1.1 to 1.9, preferably from 1.3 to 1.6, and
the sum of x and y is 2.

2. Process according to claim 1, characterized in that the alkali metal ammonium chromate double salt has a molar ammonium:alkali metal ratio of ≧2.

3. Process according to claim 1, characterized in that the thermal decomposition of the alkali metal ammonium chromate double salt takes place in the solid state at a temperature of 120 to 190° C., especially of 120 to 170° C.

4. Process according to claim 1, characterized in that the thermal decomposition of the alkali metal ammonium chromate double salt takes place in aqueous solution at a temperature of 75 to 110° C.

5. Process according to one or more of claims 1 to 4, characterized in that an aqueous solution of the decomposition product as per step c) is concentrated by evaporation before step d).

6. Process according to any of claims 1 to 5, characterized in that the alkali metal ammonium chromate double salt used, especially sodium ammonium chromate double salt, is prepared by adding NH₃ at a temperature of 55 to 95° C. to an aqueous solution of alkali metal dichromate or hydrates thereof, especially of Na₂Cr₂O₇ or Na₂Cr₂O₇*2H₂O.
